(19) United States
(12) Patent Application Publication
(10) Pub. No.: US 2006/0182859 A1
(43) Pub. Date: Aug. 17, 2006

(54) Apparatus and process for forming a decorative impression in a previously-cooked edible product and the product formed thereby

(76) Inventor: Karsten Achim Richard Arend, Toronto (CA)

Correspondence Address: SAND & SEBOLT, AEGIS TOWER, SUITE 1100, 4940 MUNSON STREET, NW, CANTON, OH, 44718-3615, US

(21) Appl. No.: 11/058,794

(22) Filed: Feb. 16, 2005

(51) Int. Cl. A21D 6/00

(52) U.S. Cl. 426/503

(57) ABSTRACT

An impressioning plate useful for creating aesthetically pleasing impressions in previously-cooked products; a process for creating the impressions and an improved previously-cooked product formed thereby. The impressioning plate includes a plurality of ridges which extend outwardly from the front face of the plate. The ridges are laid out with respect to each other and are separated by spaces so that they form a design which extends outwardly from the front face of the plate. The plate is pushed into contact with a cut outer surface of the previously-cooked product and the outwardly extending ridges compress portions of the outer surface and form recesses in the outer surface of the product. The recesses are configured in the mirror image of the design of the ridges in the plate. The compressed portions can then be filled with edible substances such as peanut butter, jelly or cream cheese. The impressioning plate may be hand-held or mechanized.

### BACKGROUND OF THE INVENTION

1. Technical Field

This invention generally relates to previously-cooked products such as slices of bread. More particularly, the invention relates to a process and apparatus for forming a decorative impression in the cooked products which is suitable for filling with spreads such as peanut butter or jelly and to the product formed thereby.

2. Background Information

Parents are always seeking novel ways for encouraging small children to eat healthy foods. Children tend to find decorative designs and patterns in their food to be appealing and are therefore more easily convinced to eat such aesthetically pleasing creations. One of the ways parents have adopted this approach, is by arranging different vegetables, meats and sauces to form the component parts of faces for example, or by drawing appealing designs on the child's food using ketchup or other similar substances.

### SUMMARY OF THE INVENTION

The device of the present invention is an impressioning plate useful for creating aesthetically pleasing impressions in previously-cooked products, such as slices of bread, and to a process using the same. The impressioning plate includes a plurality of ridges which extend outwardly from the front face of the plate. The ridges are laid out with respect to each other and are separated by spaces so that they form a design which extends outwardly from the front face of the plate. When the plate is pushed into contact with the outer surface of the previously-cooked product, the ridges compress portions of the outer surface and form recesses in the outer surface of the product configured in the mirror image of the design on the plate. An edible substance, such as peanut butter, jelly or cream cheese may be applied to the outer surface of the previously-cooked product and these edible substances tend to accumulate in the recesses. The impressioning plate may be a handheld device for use by an individual consumer, or may be mechanized for use by commercial establishments.

### BRIEF DESCRIPTION OF THE DRAWINGS

The preferred embodiment of the invention, illustrative of the best mode in which applicant has contemplated applying the principles, are set forth in the following description and are shown in the drawings and are particularly and distinctly pointed out and set forth in the appended claims.

FIG. 1 is a perspective view of an impressioning plate in accordance with the present invention;

FIG. 2 is a front view of the impressioning plate of FIG. 1;

FIG. 3 is a side view of the impressioning plate of FIG. 1;

FIG. 4 is a perspective view showing the impressioning plate being used on a slice of bread;

FIG. 5 is a perspective view of an impressioning plate in accordance with the present invention, showing a second ridge design extending outwardly from the front face of the plate;

FIG. 6 is a front view of the impressioning plate of FIG. 5;

FIG. 7 is a side view of the impressioning plate of FIG. 5;

FIG. 8 is a perspective view showing the impressioning plate of FIG. 5 being used on a slice of bread;

FIG. 9 is a perspective view of a first embodiment of mechanized impressioning plate being used on a slice of bread;

FIG. 10 is a perspective view of a second embodiment of mechanized impressioning plate being used on a series of slices of bread; and

FIG. 11 is a side view of the impressioning plate of FIG. 10.

### DETAILED DESCRIPTION OF THE INVENTION

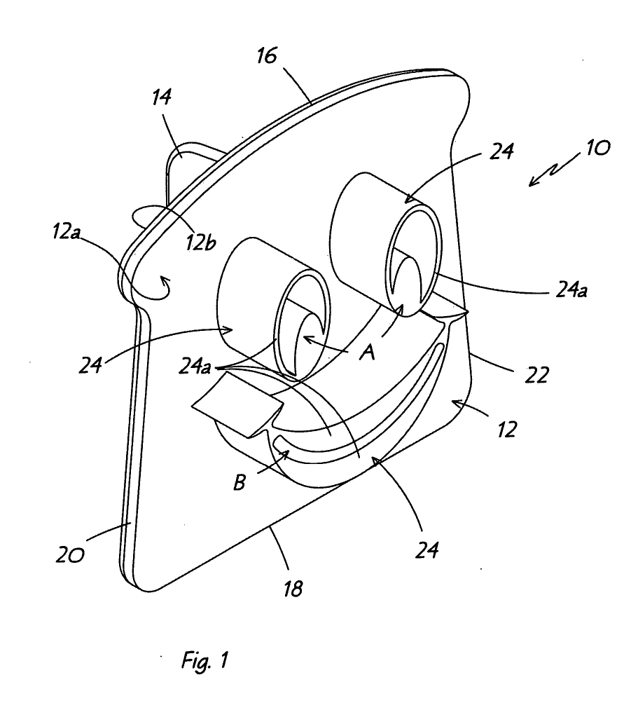

Referring to FIGS. 1-4, there is shown a hand-held impressioning plate in accordance with the present invention and generally indicated at 10. Plate 10 comprises a base 12 having a planar front face 12a and a rear surface 12b shaped to form a handle 14 (FIG. 3). Base 12 further includes an upper edge 16, a lower edge 18 and sides 20, 22. Front face 12a of base 12 is substantially continuous, being free of apertures which extend from front face 12a through to rear surface 12b of base 12. In the preferred embodiment of the invention, base 12 is shaped like a slice of bread, but it will be understood that the overall shape of base 12 may take other forms without departing from the spirit of the invention. Base 12 preferably is shaped in the form of the previously-cooked product upon which it is intended to be used. Base 12 preferably is manufactured from a dishwasher safe plastic, from a metal or any other rigid material suitable for use with foods.

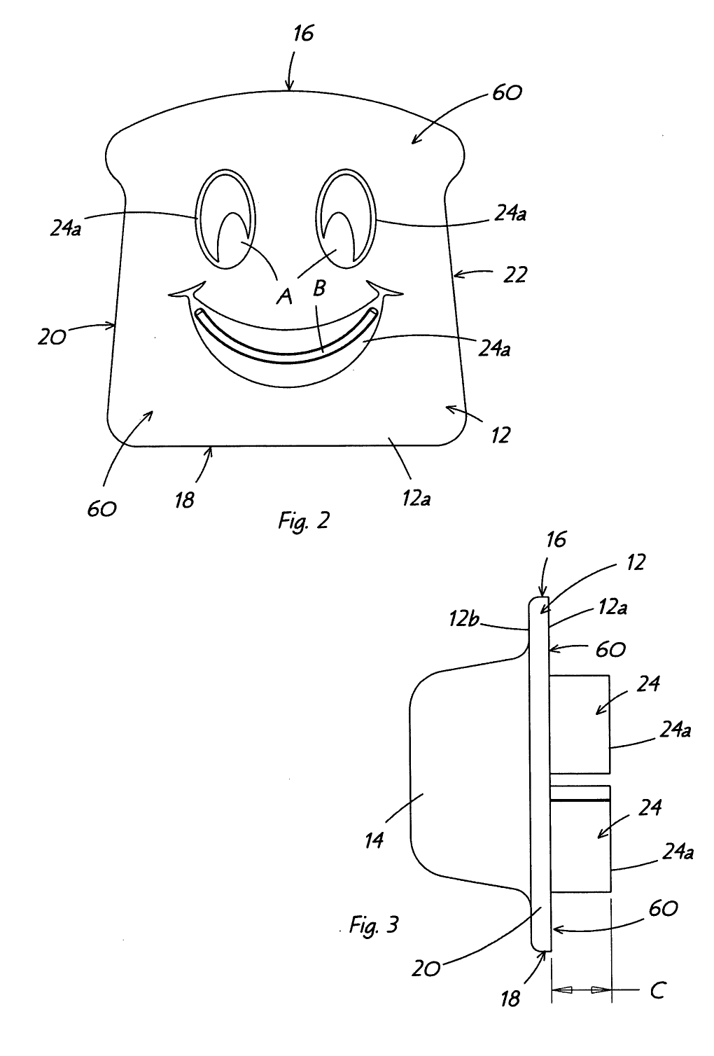

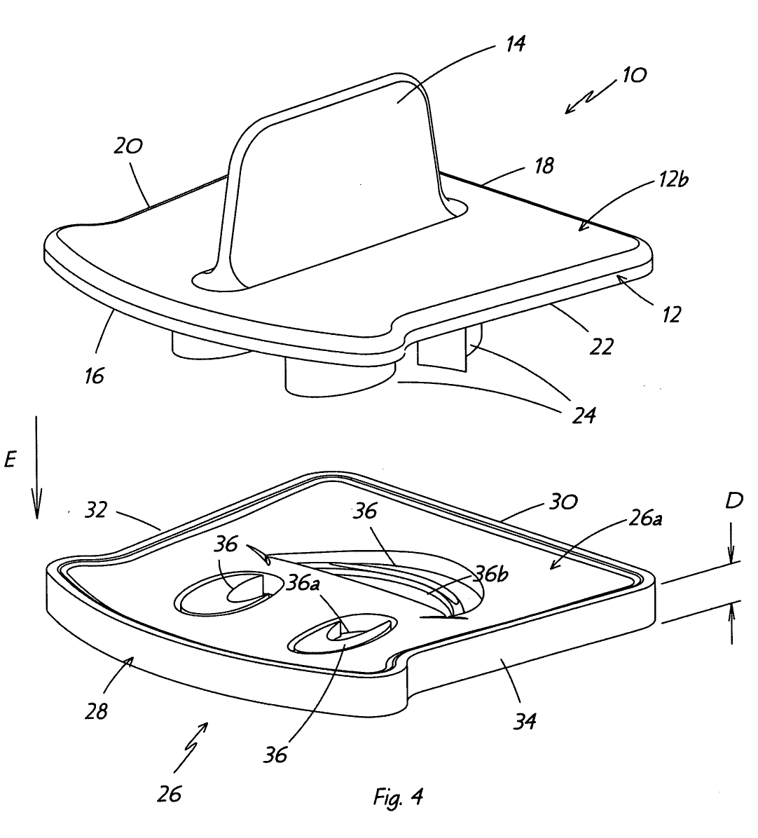

In accordance with one of the specific features of the present invention, a plurality of raised ridges 24 extend outwardly from front face 12a for a maximum distance “C” (FIG. 3). Ridges 24 are shaped and arranged to form a design, such as the happy-face shown in FIGS. 1-4. So, for example, in the case of the happy-face design, ridges 24 are shaped and spaced to form a pair of eyes and a smile and may include regions where no ridge is present such as at “A” and “B” (FIG. 2). It should be understood that different ridges 24 or different portions of ridges 24 can extend outwardly from front face 12 for different distances to aid in forming the design. Ridges 24 preferably are spaced a distance inwardly from upper and lower edges 16, 18 and from sides 20, 22 for reasons which will be later explained. Furthermore, ridges 24 preferably have rounded outermost edges 24a (FIGS. 1& 3) and do not include any cutting surfaces, so that when plate 10 is pushed into contact with an outer surface 26a of a cooked product 26 such as a cut slice of bread (FIG. 4), ridges 24 will compress regions on the outer surface of the previously-cooked product, but will not cut through to the underside of the cooked product. Furthermore, ridges 24 extend outwardly from front face 12a of base 12 for a maximum distance “C” (FIG. 3), which distance is smaller than the thickness “D” (FIG. 4) of the cooked product for which the plate 10 is designed to be used. The difference in the height “C” of ridges 24 and thickness “D” of the bread 26, aids in preventing ridges 24 from cutting through the slice of bread 26 when plate 10 is pushed downwardly into contact with the outer surface 26a of the same.

Referring to FIG. 4, plate 10 is used in the following manner on a slice of bread 26. The slice of bread 26 presents a cut outer surface 26a with outer edges 28, 30, 32 and 34 which form a perimeter for bread 26. Outer surface 26a is a cooked, cut, flat surface of the product, but is yieldable and therefore can be compressed and compacted by applying pressure thereto. The consumer grasps handle 14 of plate 10 and preferably aligns the edges 16, 18, 20 and 22 of plate 10 with the respective edges 28, 30, 32 and 34 of the slice of bread 26. Plate 10 is moved downwardly toward outer surface 26a of bread 26 in the direction of arrow “E” and until ridges 24 come into contact with outer surface 26a of bread 26. The consumer continues to apply downward pressure on plate 10 until those portions of outer surface 26a in contact with ridges 24 become inwardly compressed and compacted. Downward pressure on plate 10 also continues until the flat regions 60 (FIG. 2) on front surface 12a of plate 10 surrounding ridges 24, lie in abutting contact with the outer surface 26a of cooked product 26. surrounding ridges 24 Ridges 24 thereby form recesses 36 which mirror the shapes and configuration of ridges 24. It should be understood that the force applied by the plate 10, i.e., the downward pressure in the direction of arrow “E”, is a one-directional force applied perpendicularly to the outer surface 26a of the cooked product 26. Spreads, such as peanut butter or jelly (not shown) can then be applied to outer surface 26a and these spreads will tend to accumulate in recesses 36 thereby highlighting the features of the design of the ridges 24. So, in the example shown in FIGS. 1-4, the recesses 36 take the form of a pair of eyes 36a and a smiling mouth 36b. A first spread can be applied to the first recesses 36a and a different spread can be applied to the second recess 36b to create a more aesthetically appealing design. A second slice of bread (not shown) may be placed over the outer surface 26a to form a sandwich. The recesses 36 would then help keep the spreads from leaking out of the sandwich. If the slice of bread 26 is kept as an open sandwich, the recesses lend aesthetic appeal to that open sandwich. It is advantageous that ridges 24 do not extend to the edges 16, 18, 20 or 22 of plate 10 because the recesses 36 then created would extend to the edges 28, 30, 32 or 34 of bread 26 and would therefore potentially allow the spreads to leak out of recesses 36.

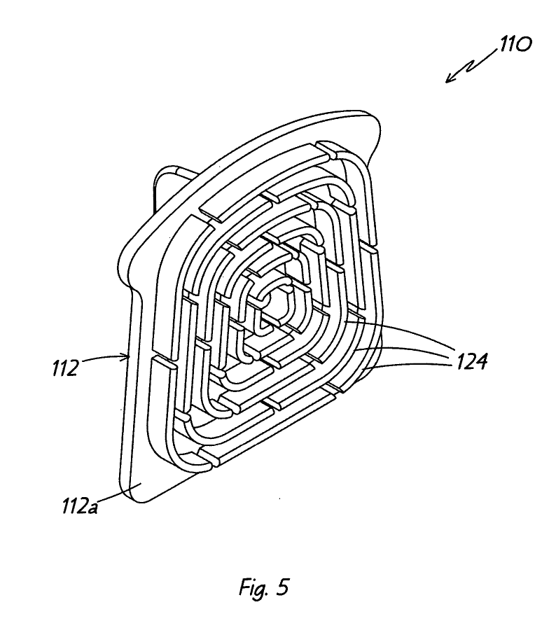

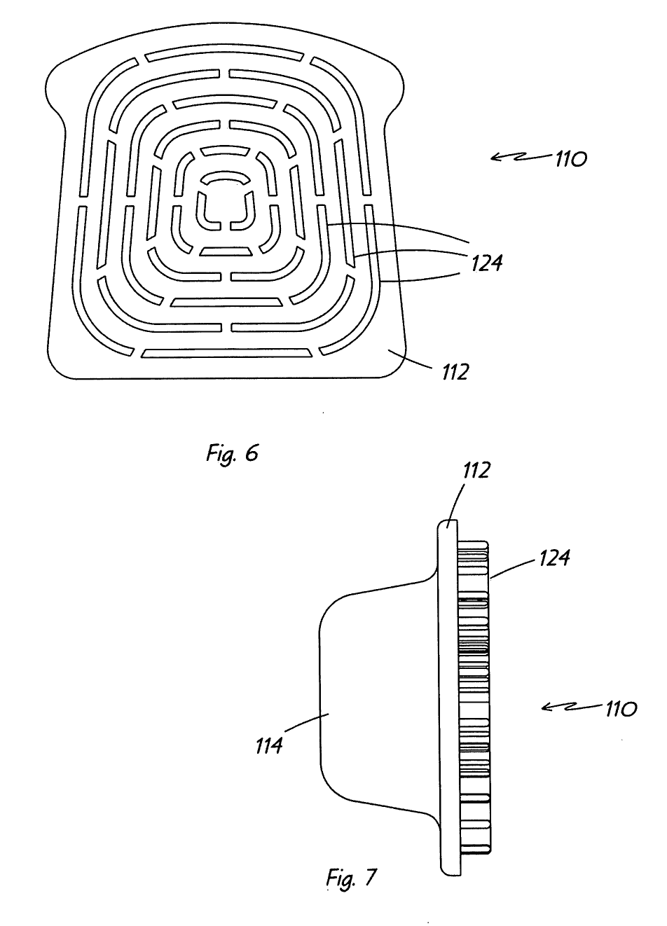

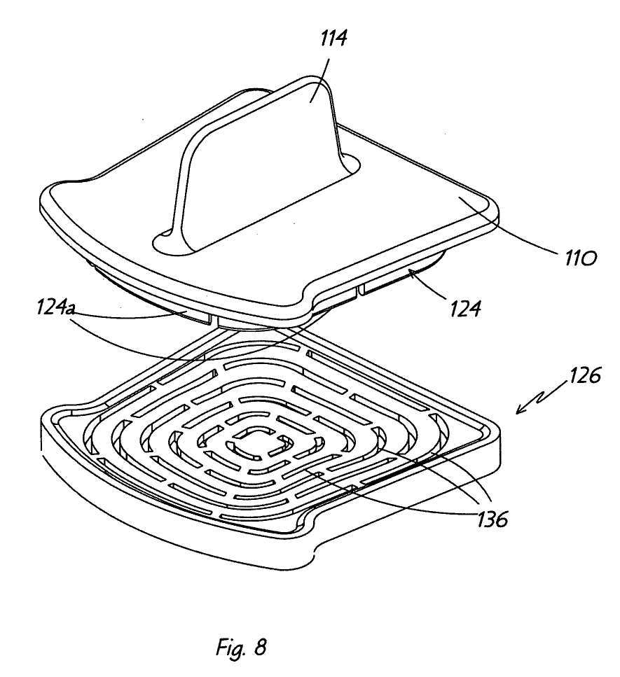

A second possible ridge design is shown in FIGS. 5-8 with the ridges being generally indicated at 124. Ridges 124 again have rounded outer edges 124a and extend outwardly from a front face 112a of base 112. When plate 110 is pressed downwardly into contact with a cooked product, such as a slice of bread 126, ridges 124 form a plurality of recesses 136 in the outer surface 126a of bread 126. Spreads applied to outer surface 126a tend to accumulate in recesses 136 and thereby create both a visually appealing open sandwich and a non-leaking closed sandwich.

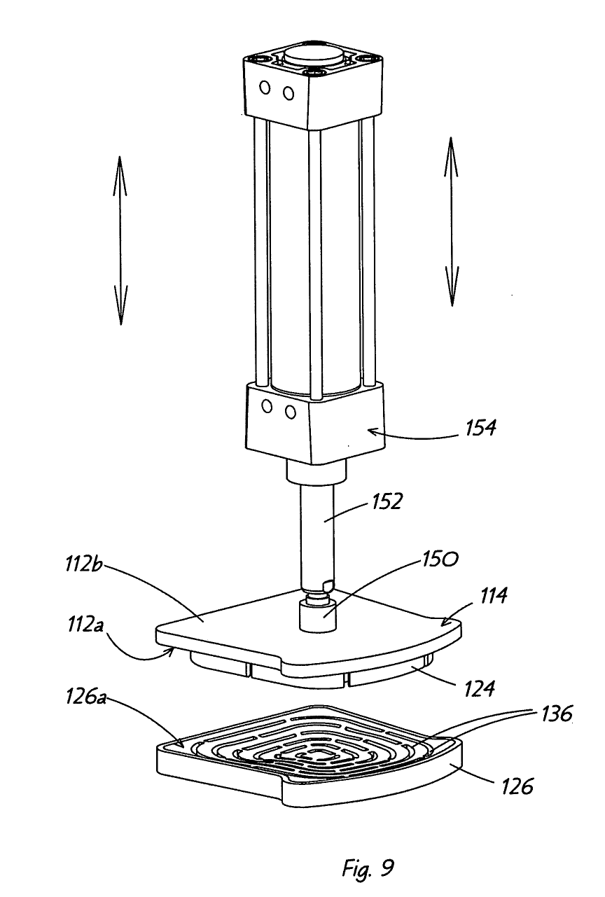

While the previously described embodiments of impressioning plate 10, 110 have a handle 14, 114, respectively, which extends from the rear surface thereof and the plate 10, 110 is manipulated by means of that handle 14, 114, it will be understood that the plate may alternatively be gripped in any other manner and manipulated into contact with the outer surface of a previously-cooked edible product. So, for instance, as is seen in FIG. 9, plate 114 may include a female socket 150 on its rear surface 112b. Socket 150 may be threadably connected to an arm 152 of a reciprocating stamping machine 154. Arm 152 selectively moves downwardly to push ridges 124 into contact with the outer surface 126a of a previously-cooked product 126, thereby causing the pattern of ridges 124 to be stamped into cooked product 126. Arm 152 is then moved upwardly out of contact with product 126, leaving a plurality of recesses 136 formed in product 126. Stamping machine 154 moves the front face 112a of plate 110 up and down substantially parallel to the outer surface 126a of the previously-cooked product 126. Plate 110 may also be heated.

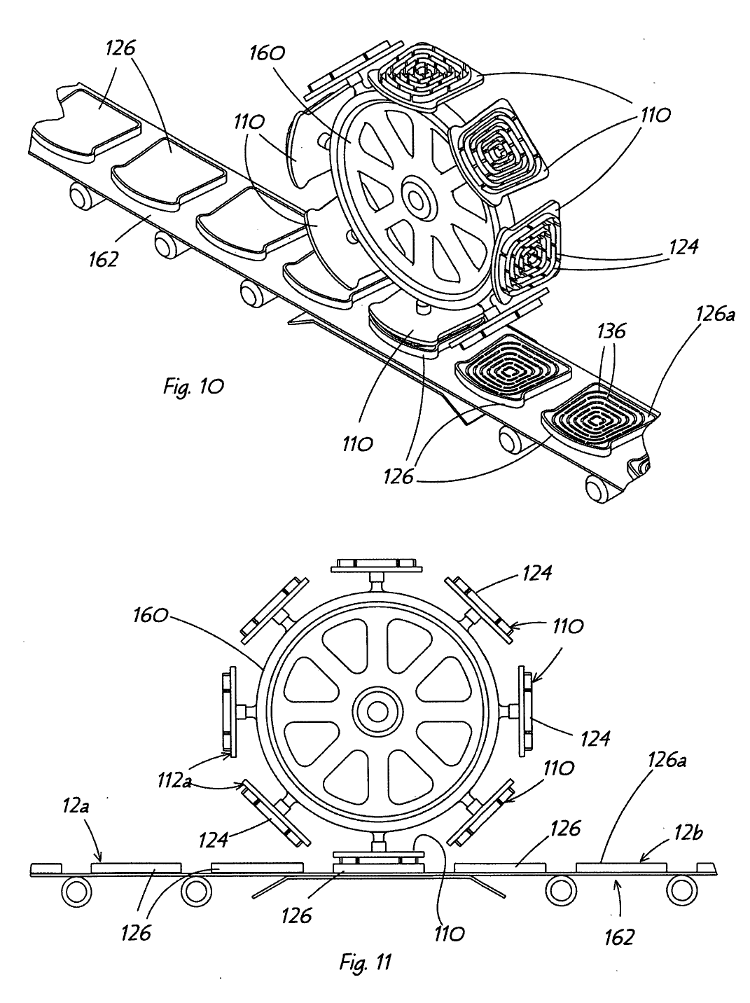

Alternatively, as is shown in FIG. 10, a plurality of impressioning plates 110 may be connected to a rotatable wheel 160. A conveyor belt 162 moves a plurality of previously-cooked products 126 sequentially beneath wheel 160. As wheel 160 rotates, each plate 110 sequentially come into contact with the outer surface 126a of one of products 126. The front face 112a of each plate 110 rotates into contact with outer surface 126a of product 126. The design of ridges 124 is therefore sequentially stamped into outer surface 126a unlike the manner in which the design is stamped into the product 126 using the stamping machine 152, where the design is formed all at the same time. Once the products 126 have the recesses 136 stamped into them, the products 126, which are slices of bread in this instance, may then be reassembled into sliced loaves of bread, which are subsequently packaged and sold to consumers.

It will be understood that while a happy-face and a geometric design of ridges 24 have been disclosed above, any other desired pattern or design could be formed by ridges 24 on front face 12a of plate 10 without departing from the spirit of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A plate for forming an impression in an outer surface of a previously-cooked edible product, said plate comprising:
a base having a substantially continuous front face, a rear surface and outer edges;
one or more ridges extending outwardly from the front face of the base, said ridges being shaped and spaced so as to form a pattern on the front face; and whereby the one or more ridges are adapted to form a plurality of complementary-shaped recesses in the outer surface of the previously-cooked edible product when the front face of the plate is pushed into contact with the outer surface of the product.

2. The plate as defined in claim 1, wherein the ridges are generally free of any cutting edges.

3. The plate as defined in claim 2, wherein the ridges have outermost edges and the outermost edges are generally rounded.

4. The plate as defined in claim 3, further comprising a gripping means for manipulating the base.

5. The plate as defined in claim 4, wherein the gripping means is a handle extending outwardly from the rear surface of the base.

6. The plate as defined in claim 4, wherein the gripping means is connected to a powered machine.

7. The plate as defined in claim 6, wherein the powered machine is a reciprocating stamping machine which moves the front face of the plate up and down substantially parallel to the outer surface of the previously-cooked product.

8. The plate as defined in claim 7, wherein the plate is heated.

9. The plate as defined in claim 7, wherein the powered machine is a rotatable wheel onto which one or more plates are mounted, and wherein the plates are sequentially rotated into contact with the outer surface of previously-cooked products

10. The plate as defined in claim 4, wherein the pattern formed by the ridges is an ornamental design.

11. The plate as defined in claim 10, wherein the ornamental design is a smiley-face.

12. The plate as defined in claim 4, wherein the pattern formed by the ridges is a geometric design.

13. A process for treating previously-cooked products of the type having outer edges and an exposed upper surface comprising the steps of:
providing a device for treating the cooked product; wherein the device includes a plurality of ridges formed on an outer surface of the device;
aligning the device with the cooked product;
applying pressure to the device to selectively compress portions of the upper surface of the cooked product to form one or more recesses therein.

14. The process of claim 13, wherein the outer surface of the device includes a substantially flattened region and wherein the ridges extend outwardly away from the flattened region; and wherein the step of applying pressure to the device continues until the flattened region of the outer surface of the device lies in abutting contact with the upper surface of the cooked product.

15. The process of claim 13, wherein the step of compressing portions of the outer surface takes place all at one time so that portions of the outer surface proximate a first outer edge of the cooked product are compressed simultaneously with portions of the outer surface proximate an opposing second outer edge thereof.

16. The process of claim 13, wherein the step of compressing portions of the outer surface is of a sequential nature so that portions of the outer surface proximate a first outer edge of the cooked product are compressed before portions of the outer surface proximate an opposing second outer edge thereof.

17. An improved previously-cooked edible product of the type having an exposed upper surface and a bottom surface; the improvement comprising:
one or more recesses compressed into the upper surface, said recesses being formed in an ornamental pattern.

18. An improved previously-cooked edible product as defined in claim 17, wherein the ornamental pattern is a smiley-face having eyes and a mouth.

19. An improved previously-cooked edible product as defined in claim 17, wherein the ornamental pattern is a geometric design.

20. An improved previously-cooked edible product as defined in claim 17 further comprising an edible food spread applied to the outer surface; whereby the edible food spread accumulates in the recesses in the upper surface of the cooked product.
